(19) United States
(12) Patent Application Publication
(10) Pub. No.: US 2010/0250440 A1
(43) Pub. Date: Sep. 30, 2010

(54) Web based monitoring, management and contest based on collected power consumption data

(76) Inventors: Eugene Wang, Palo Alto, CA (US); David Moss, Tucson, AZ (US)

Correspondence Address: EUGENE WANG, 620 Lowell Ave, PALO ALTO, CA, 94301, US

(21) Appl. No.: 12/383,931

(22) Filed: Mar. 30, 2009

(51) Int. Cl. G06Q 30/00; G08C 15/06; G06Q 10/00

(52) U.S. Cl. 705/63; 340/870.02; 705/34; 705/412; 705/14.25

(57) ABSTRACT

A web based monitoring and management system for collection and distribution of power consumption information. The power consumption information is collected by an intelligent power meter in one embodiment, and by a collector device in another. The power consumption information is communicated to a remote server for analysis, reporting and managing a power savings/green energy contest. The collector device or the intelligent power meter receives monitoring data from a number of electrical appliances with which it is communicatively coupled. Communication between the collector device that receives monitoring data from a number of electrical appliances and the monitoring devices occurs over a power line.

### CROSS REFERENCES TO RELATED APPLICATIONS

The present patent application is related to and makes reference to a co-pending application, entitled “A MONITORING SYSTEM FOR COLLECTION AND DISTRIBUTION OF A POWER CONSUMPTION INFORMATION”, filed on Mar. 31, 2009, docket number GWPP2009UI. The complete subject matter of the above-referenced United States Patent Application is hereby incorporated herein by reference, in its entirety. The present patent application and the above-referenced United States Patent Application share the same inventors and have the same filing date.

### BACKGROUND

1. Technical Field

The present invention relates generally to energy saving and power consumption monitoring and particularly to a solution wherein power consumption by individual appliances and devices are monitored and reported and a contest is managed to award winners based on their power usage profile.

2. Related Art

Power consuming appliances are becoming ubiquitous. People use electrical tools and appliances all over their residences. Some electrical appliances are turned on and seldom turned off, even when the user does not need the appliance or make use of it. Most people living in a modern house have a TV, a refrigerator, a washing machine, a washer, a dryer, a heating system, an air conditioner, etc. Most of these devices consume a lot of power when they are plugged into power outlets, some even when they are not being used.

Every day people use a lot of electricity for running electrical tools and appliances but they don't know which appliances are consuming how much power. Every month people get an electric bill and they would like to lower it, but they do not know how to reduce their monthly electrical bill. Every year mankind adds to global warming but we do not individually have an easy way to help reduce global warming. People do not seem to be able to control power consumption at their homes and work places.

Unfortunately, despite widespread acceptance of green house effects and despite rise in the price of crude oil, people have not been provided with effective power saving technologies. People are being encouraged to turn off light bulbs when they are not in a room. Some appliance can be turned off if they are not being used. However, turning off a refrigerator when a user is travelling it is not an option as food stored in the refrigerator is likely to get spoiled when it is turned off.

Often people do not know how much power they can save by following all the typical power saving recommendations. Well meaning individuals have no idea how effective all their power saving efforts has been. Even if one were to use green electrical appliances, one does not know if one can be more effective in saving power by adopting better usage patterns.

Most residential buildings have an electric meter or energy meter that measures the amount of electrical energy supplied to a residence or business. The most common type is a kilowatt hour meter. Typically, the utilities record the values measured by these meters to generate an invoice for the electricity. They may also record other variables including the time when the electricity was used. People are sent electricity usage bills by the utilities periodically.

Most modern electricity meters operate by continuously measuring the instantaneous voltage (in volts) and current (in amperes) and finding the product of these to give instantaneous electrical power (in watts) which is then integrated against time to give energy used (joules, kilowatt-hours etc). The meters fall into two basic categories, electromechanical and electronic. Electric meters are usually installed outside residential neighborhoods to enable meter readers associated with the utilities to stop by and read the meters to prepare a monthly bill. These electric meters do not provide details of how energy efficient individual appliances are in a premises. They do not provide details of how the power is being consumed in the premises. Typically, a user does not get much information from these meters, as they are designed for a meter reader to collect a total usage data or billing information once a month or so.

There is a problem educating users on effective power management techniques that saves them money by reducing power consumption. There is a problem in sharing success stories when some users are able to significantly lower their electric bills by better management of power consumption at home. Quite often, these individuals who have lowered their electric bills do not know how much individual appliances have contributed towards the savings in energy bills.

In view of the foregoing considerations, it is clear that there is a need for an improved system and method for measuring power consumption and monitoring power usage.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a perspective block diagram of a web based monitoring and management system that collects a power consumption information from electrical appliances in a premises and conducts a power savings contest to determine winners based on their power consumption information.

FIG. 2 is a flow chart of an exemplary operation conducted by the web based monitoring and management system wherein an intelligent power meter monitors energy consumption by individual electrical appliances employing a power strip and a watt meter for monitoring purposes.

FIG. 3 is a perspective block diagram of an exemplary monitoring system that monitors appliances in a premises wherein the monitoring system comprises a plurality of monitoring devices, each of the plurality of monitoring devices capable of being used to monitor at least one of a plurality of appliances that are electrically and communicatively coupled to it.

### DETAILED DESCRIPTION OF THE DRAWINGS

The present invention provides an elegant means of monitoring power consumption of individual appliances in a residence or building wherein the power consumption is monitored by the use of new and innovative meters and monitoring devices built in accordance with the present invention. Power consumption information is collected by an intelligent power meter or a collector device and is communicated to a remote server for analysis, reporting and managing a power savings/green energy contest.

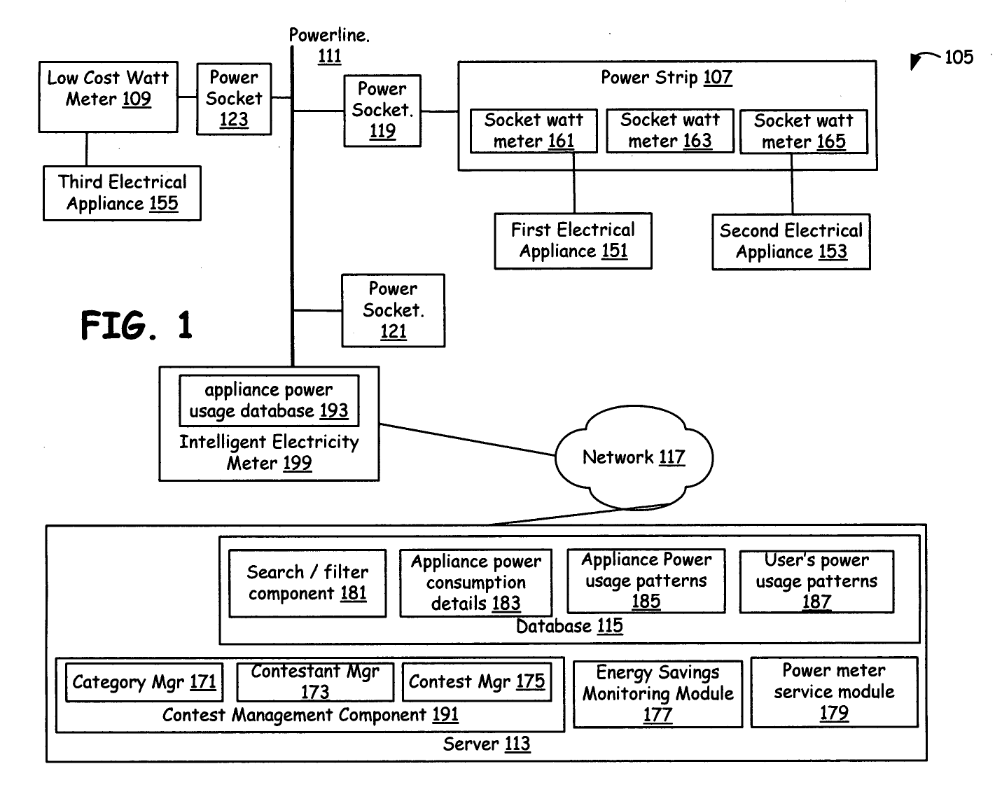

FIG. 1 is a perspective block diagram of a web based monitoring and management system 105 that collects a power consumption information from electrical appliances 151, 153, 155 in a premises and conducts a power savings contest to determine winners based on their power consumption information. The web based monitoring and management system 105 is capable of collecting and distributing the power consumption information and conducting one or more power savings contests. It comprises a low cost watt meter 109 that is employed between, and electrically coupled to, a power socket 123 and a third electrical appliance 155. It also comprises a power strip 107 that contains a plurality of socket meters 161, 163, 165, each capable of being electrically coupled to, and monitoring power supplied to, electrical appliances 151, 153.

The web based monitoring and management system 105 also comprises an intelligent electricity meter 199 that collects an energy consumption data for electrical appliances from the low cost watt meter 109 and the power strip 107. The intelligent electricity meter 199 monitors energy consumed by individual electrical appliances 155, 151, 153, stores them locally, and subsequently communicates the energy consumption data to a server 113. The intelligent electricity meter 199 is typically plugged into a powerline 111 or otherwise directly connected to the powerline 111. It communicates with the low cost watt meter 109 and the power strip 107 to collect energy consumption data associated with individual electrical appliances 155, 151, 153. Such communication occurs over the powerline 111 or via a Bluetooth communication links or 802.11 based communication means. Thus, the intelligent electricity meter 199 receives monitoring data from the plurality of electrical appliances 151, 153, 155 with which it is communicatively coupled via watt meter 109 or power strip 107.

The power strip 107 comprises a plurality of socket watt meters 161, 163, 165, that each provide means to supply power to and monitor power consumption by an electrical appliance, such as the first electrical appliance 151. The power strip 107 monitors the energy consumption by the first electrical appliance 151 that is plugged into a first socket watt meter 161 and by the second electrical appliance 153 that is plugged into a socket watt meter 165. It communicates the energy consumption data to the intelligent electricity meter 199 over the powerline 111 (or WiFi/Bluetooth is necessary). The intelligent electricity meter 199 processes the energy consumption data and locally stores it in a appliance power usage database 193. Subsequently it communicates the energy consumption data to the server 113. Such communication between the intelligent electricity meter 199 and the server 113 occurs over a network 117. In one embodiment, the network 117 is Internet.

Communication between the intelligent electricity meter 199 that receives monitoring data from a number of electrical appliances 151, 153, and the low cost watt meter 109 or the power strip 10 occurs over a power line 111. Other means of communication such as Bluetooth and WiFi are also contemplated in some embodiments.

When a collector device 199 is used in the place of the intelligent electricity meter 199, communication between the collector device 199 that receives monitoring data from a number of electrical appliances 151, 153, and the monitoring devices 107, 109, occurs over a power line 111. Other means of communication such as Bluetooth and WiFi are also contemplated in some embodiments.

The communication means for communication between the intelligent electricity meter 199 and the low cost watt meter 109 and the power strip 107 is often the powerline 111 to which they are all electrically coupled. Communications over the powerline 111 occurs by impressing a modulated carrier signal on the wiring system used to provide power within the premises. The powerline 111 is used to provide one or more types of powerline communications using different frequency bands, depending on the signal transmission characteristics of the power wiring used. Most power wiring system within a were originally intended for transmission of AC power and therefore have only a limited ability to carry higher frequencies for communication. Data transfer over the powerline 111 occurs, in one embodiment, over a low-frequency (about 100-200 kHz) carrier impressed the powerline 111. In a different embodiment, a higher data rate is employed that provides a local area network operating at millions of bits per second. In a related embodiment, the powerline 111 is used to implement a home network employing a technology that corresponds to one of the specifications provided by the HomePlug Powerline Alliance, the Universal Powerline Association, the HD-PLC Alliance or Broadband over Powerlines (BPL).

In one embodiment, the intelligent electricity meter 199 is a power monitoring hub that is communicatively coupled to a remote power meter service module 179 managed by the server 113. The power meter service module 179 facilitates display, over the web, of power consumption data by appliance, by premises, by user, etc. In general, it helps display detailed home energy information and shows a user how to save money, and how much can be saved by better energy consumption management. In a specific embodiment, the power meter service module 179 is a Google PowerMeter based module to which the power monitoring hub 199 provides detailed information on power consumption by appliance at a user premises organized by time of data collection with peak power usage and low power durations highlighted.

In general, the web based monitoring and management system 105 provides customized power usage information to the user via the server 113. In addition, it predicts power wasted by the user based on a discerned pattern of usage of appliances at the user's premises. For example, power consumption data collected and processed by the intelligent electricity meter 199 is used to predict power wasted by the user, and the user is informed of the power wasted and recommendations are made to the user on how to reduce the wastage.

In general, the low cost watt meter 109 comprises an appliance connector for a third electrical appliance 155 to be plugged into. It employs the powerline 111 in the premises to communicate power usage data to the intelligent electricity meter 199 and to receive commands that facilitate management of power consumption by the third electrical appliance 155. The low cost watt meter 109 plugs into a 220 VAC power socket associated with the powerline 111 in the premises and it communicates an appliance power usage data associated with the third electrical appliance 155 to the intelligent electricity meter 199 over the powerline 111 in the premises.

The powerline 111 in the first premises is also used by the power strip 107 to supply power to the first electrical appliance 151 that is plugged into the socket watt meter 161. The power strip 107 comprises a plurality of socket watt meters 161, 163, 165 and it plugs into a 110 VAC power socket, such as a power socket 119. The power strip 107 provides power connectivity to the plurality of electrical appliances 151, 153 that each plug into one of the plurality of sockets watt meters 161, 163, 165. It also communicates an appliance power usage data associated with the plurality of electrical appliances 151, 153 to the intelligent electricity meter 199 over the powerline 111. The intelligent electricity meter 199 locally displays the appliance power usage data associated with the plurality of appliances 151, 153 using a display disposed on/integrated into the intelligent electricity meter 199. In one embodiment, a user can access the appliance power usage data associated with the plurality of appliances 151, 153 from the server 113, using a device such as a mobile phone or a PC/laptop.

In one embodiment, the intelligent electricity meter 199 is a green power hub that communicates over the powerline 111 with the power strip 107 and captures the appliance power usage data associated with the plurality of appliances 151, 153 and pushes it to a remote power meter service module 179, and to an online power saving contest management component 191. The online power saving contest management component 191 is associated with server 113 and it comprises a category manager 171 that supports a plurality of appliance categories and a contestant manager 173 that manages contestant contact information and contestant details. It also comprises a contest manager module 175 that, based on tracked power usage information, determines winners for the plurality of appliance categories and awards prizes. The tracked power usage information, in a related embodiment, comprises an appliance power usage data associated with the plurality of appliances 155, 151, 153.

In one embodiment, the tracked power usage information, for each of the plurality of appliances 151, 153, 155, comprises at least the following items of information: identification, time, kilo-watt-hours, KWH-per-day, watts, amps and power factor.

The server 113 comprises a database 115 and the contest management component 191. It also comprises a energy savings monitoring module 177, and the power meter service module 179. The database 115 comprises a search/filter component 181, an appliance power consumption details 183 that has detail information on reference power consumption data for each category of electrical appliances, actual power consumption data for each appliance used by a user etc. It also comprises an appliance power usage patterns 185 that contains typical power usage patterns for most appliances as well as specific power usage patterns for appliances owned or operated by the user at his premises. The database 115 also contains a user's power usage patterns 187 that computes an overall model of the user's power consumption patterns taking into account user's habits, his work hours, his appliances usage patterns, etc.

In one embodiment, communication between the intelligent electricity meter 199 and the low cost watt meter 109 or the power strip 107 occurs over a secure channel that employs encryption for security, wherein encoded commands are sent to the low cost watt meter 109 or the power strip 107 by the intelligent electricity meter 199 over the secure channel.

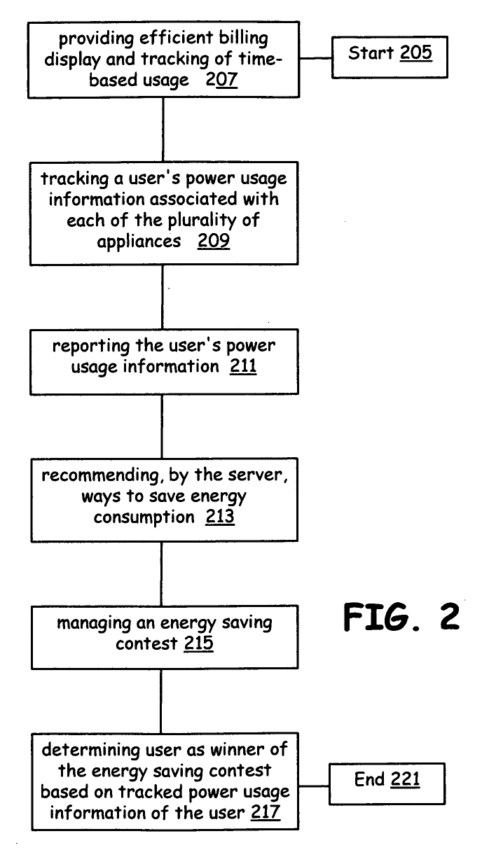

FIG. 2 is a flow chart of an exemplary operation conducted by the web based monitoring and management system wherein an intelligent power meter 199 monitors energy consumption by individual electrical appliances 151, 153, 155 employing the power strip 107 and the low cost watt meter 109 for monitoring purposes. At a start block 205, the operation starts when the monitoring devices, such as the power strip 107, are plugged into power sockets in a premises, such as a residence, selectively after initial configuration. For example, the power strip 107 is installed between a power socket 119 and a first electrical appliance 151 after initial configuration.

At a next block 207, the web based monitoring and management system provides efficient billing display and tracking of time-based usage by an intelligent electricity meter 199 that electrically coupled to a plurality of appliances 151, 153, 155 at a first premises. Then, at a next block 209, the intelligent electricity meter conducts tracking, of a user's power usage information associated with each of the plurality of appliances. At a next block 211, the intelligent electricity meter 199 reports the user's power usage information to the server 113.

Then, at a next block 213, the server recommends ways to save energy consumption by the user based on appliances used by the user and power consumption patterns. It maps the user's energy consumption data to money saved. It displays money saved and energy wasted, if requested by user. Then, at a next block 215, the server 113 manages an energy saving contest. This involves identifying participants, computing power usage patterns, power saved, etc. for each participant, etc. At a next block 217, the server 113 employs the contest management component 191 and attempts to determine one or more winners based on the user's power consumption data, energy saved by the users, energy wasted by the users, etc. Then, one or more users are determined to be winners of the energy saving contest (based on tracked power usage information of the user, etc.) and the winners are contacted and their winning participation is presented on the server 113. The reasons why the winners are able to conserve energy or reduce energy consumption are explained by appropriate analysis on the server 113. Then, at the end block 221, the operation terminates.

In one embodiment of the method, at the block 207, the intelligent electricity meter 199 is replaced by a collector 199 capable of collecting user's power usage information. The collector 199 is also able to report it to the server 113. In addition, power usage is monitored employing a plurality of monitoring devices, such as a power strip 107 or a first monitoring device 321 at the next step 209. Each of the plurality of monitoring devices 107, 109 is plugged into the powerline 111 and to at least one of a plurality of appliances 151, 153, 155, thereby enabling power consumption monitoring and collection of power consumption data, at the next step 211. Also, at the step 211, the server 113 displays the user's power usage information employing a power meter, such as a Google PowerMeter.

In one embodiment, at the step 209, a collector device 199 receives commands from the server 113 and executes those commands or forwards them to the power strip 107, as appropriate. Thus, the collector 199 sends the commands to one or more of the plurality of monitoring devices 107, 109 in order to manage power consumed by the associated ones of the plurality of appliances 151, 153, 155.

In one embodiment, communication between the collector 199 and the plurality of monitoring devices 107, 109 occurs over a secure channel that employs encryption for security, wherein the commands are sent to the monitoring devices over the secure channel. In addition, at the start step 205, the monitoring devices such as the power strip 107, and the low cost watt meter 109 conduct automatic and quick configuration. For example, each of the monitoring devices 107, 109 are directly plugged into the collector 199. The quick configuration comprises creation and setup of a secure key for secure communications.

In another embodiment, at the step 209, tracking a user's power usage information associated with each of the plurality of appliances 151, 153, 155 comprises periodically getting a power usage data from each of the plurality of monitoring devices 107, 109, timestamping it, and storing it for local display and for subsequent reporting to the server 113.

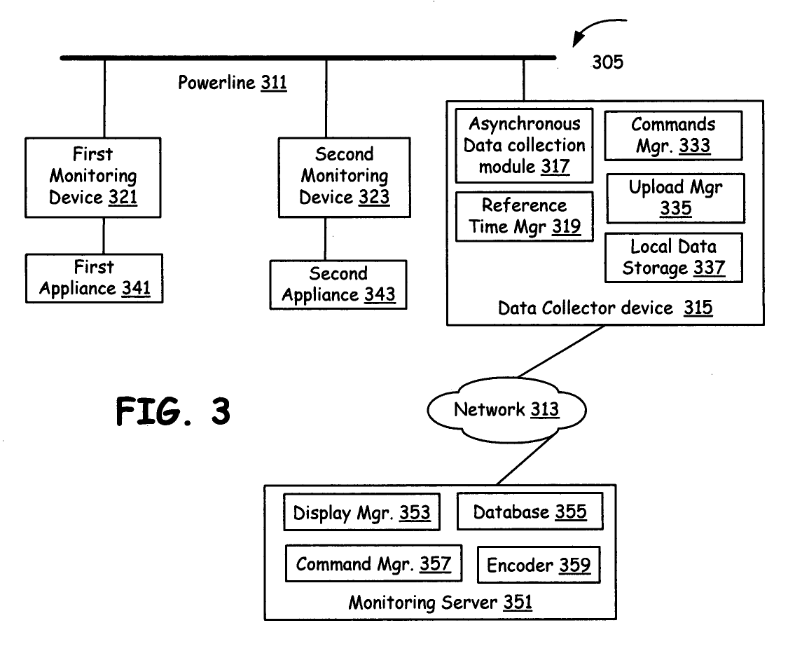

FIG. 3 is a perspective block diagram of an exemplary monitoring system 305 that monitors appliances in a premises wherein the monitoring system comprises a plurality of monitoring devices 321, 323, each of the plurality of monitoring devices 321, 323 capable of being used to monitor at least one of a plurality of appliances 341, 343 that are electrically and communicatively coupled to it. The monitoring system 305 comprises a data collector device 315 that is communicatively coupled to, and interacts with, the plurality of monitoring devices 321, 323. The data collector device 315 communicates commands to the plurality of monitoring devices 321, 323 and monitors the power consumption of the plurality of appliances 341, 343.

The data collector device 315 comprises an asynchronous data collection module 317, a reference time manager 319, a commands manager 333, an upload manager 335 and a local data storage 337. The monitoring server 351 comprises a display manager 353, a command manager 357, a database 355 and an encoder 359.

The data collector 315 asynchronously gathers a reading data from the plurality of monitoring devices 321, 323, employing the asynchronous data collection module 317, and stores it locally employing the local data storage 337, until it subsequently transfers the data over the network 313 (such as Internet) to a monitoring server 351 employing one of an efficient encoded format and a XML based format. The reading data gathered at the data collector device 315 is timestamped locally before being uploaded to the monitoring server 351, wherein the collector obtains a reference time from the monitoring server to timestamp the reading data locally.

The reference time manager 319 obtains a reference time from an external source such as the monitoring server 351 and uses it to timestamp data collected from the first monitoring device 321 and the second monitoring device 323. The asynchronous data collection module 317 facilitates collecting data pushed from any of the monitoring devices 321, 323. The upload manager 335 facilitates communication of the data from the data collector device 315 to the monitoring service 351, where it can be stored in the database 355, processed or displayed by the display manager 353.

The encoder 359 makes it possible to efficiently encode commands sent to the data collector device 315 using the command manager 357. Encoding makes the commands sent compact and efficient. Various forms of encoding are contemplated, including the use of Lempel-Ziv-Welch (LZW) encoding.

The monitoring server 351 collects data from the data collector device 315. The data collector device 315 gathers either a latest reading data or a batch of readings that were collected from the appliances 341, 343 within a configurable duration of time. The monitoring server 351 pushes the commands to the data collector device 315. The data collector device 315 communicates the commands to one or more of the plurality of monitoring devices 321, 323. One or more of the plurality of monitoring devices 321, 323 execute the commands received and delivering a response, if any to the data collector device 315. The commands are one or more from the set comprising SETUP, POWEROFF, POWERON, LOWPOWER, HIGHPOWER, STANDBY, REPORT, RESET and CLEAR. In general, the reporting data received fm the first monitoring device 321 and the second monitoring device 323 comprise at least the following items of information: identification, time, kilo-watt-hours, KWH-per-day, watts, amps and power factor.

In one embodiment, communications between the data collector device 315 and the plurality of monitoring devices 321, 323 occurs over a secure channel that employs encryption for security, wherein the commands are sent to the monitoring devices 321, 323 over the secure channel. The data collector device 315 also conducts automatic and quick configuration of the monitoring devices 321, 323 when each of the monitoring devices 321, 323 are directly plugged into the data collector device 315. A quick configuration of the monitoring devices 321, 323 comprises at least the creation and setup of a secure key for secure communications.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1. A web based monitoring and management system comprising:
an intelligent electricity meter electrically coupled to a plurality of appliances at a first premises, the intelligent electricity meter providing efficient billing display and tracking of time-based usage of electric power by the plurality of appliances;
the intelligent electricity meter tracking a user's power usage information for each of the plurality of appliances, and reporting it to a server;
a contest management component at the server tracking the user's power usage information, recommending ways to reduce energy consumption by the user, and mapping reduced energy consumption to money saved; and
the contest management component determining the user as a winner of an energy saving contest based on tracking of the user's power usage information and money saved.

2. The web based monitoring and management system of claim 1 wherein the intelligent electricity meter is a power monitoring hub that is communicatively coupled to a remote power meter managed and displayed by the server, wherein he remote power meter is capable of displaying power consumed by each of the plurality of appliances, power saved by intelligent power management and power wasted.

3. The web based monitoring and management system of claim 1 providing customized power usage information to the user.

4. The web based monitoring and management system of claim 1 wherein the intelligent electricity meter predicts power wasted.

5. The web based monitoring and management system of claim 1 further comprising:
a powerline in the first premises;
a low cost watt meter comprising an appliance connector for a first appliance to be plugged into;
the low cost watt meter plugging into a 220 VAC power socket associated with the powerline in the premises; and
the low cost watt meter communicating an appliance power usage data associated with the first appliance to the intelligent electricity meter over the powerline in the first premises.

6. The web based monitoring and management system of claim 1 further comprising:
a powerline in the first premises;
a power strip comprising a plurality of socket watt meters, that plugs into a 110 VAC power socket;
the power strip providing power connectivity to a plurality of appliances that each plug into one of the plurality of sockets watt meters;
the power strip communicating an appliance power usage data associated with the plurality of appliances to the intelligent electricity meter over the powerline in the first premises; and
the intelligent electricity meter displaying the appliance power usage data associated with the plurality of appliances.

7. The web based monitoring and management system of claim 6 wherein the intelligent electricity meter is a green hub that communicates over the powerline with the power strip and captures the appliance power usage data associated with the plurality of appliances and pushes it to a remote power meter and to an online power saving contest service module.

8. The web based monitoring and management system of claim 7 wherein the online power saving contest service module is associated with the server and wherein the online power saving contest service module comprises:
a category manager that supports a plurality of appliance categories;
a contestant manager that manages contestant contact information and contestant details; and
a contest manager module that, based on a tracked power usage information that comprises the appliance power usage data associated with the plurality of appliances, determines winners for the plurality of appliance categories and awards prizes.

9. The web based monitoring and management system of claim 8 wherein tracked power usage information, for each of the plurality of appliances, comprises at least the following items of information: identification, time, kilo-watt-hours, KWH-per-day, watts, amps and power factor.

10. A monitoring system that monitors appliances, the monitoring system comprising:
a plurality of monitoring devices, each of the plurality of monitoring devices capable of being used to monitor at least one of a plurality of appliances that are electrically coupled to it;
a data collector device communicatively coupled to and interacting with the plurality of monitoring devices; and
the data collector device communicating commands to the plurality of monitoring devices and monitoring the power consumption of the plurality of appliances.

11. The monitoring system of claim 10 wherein the data collector device asynchronously gathers a power reading data from the plurality of monitoring devices and stores it locally until it subsequently transfers the data over Internet to a monitoring server employing one of an efficient encoded format and a XML based format.

12. The monitoring system of claim 11 wherein the power reading data gathered at the data collector is timestamped locally before being uploaded to the monitoring server, wherein the data collector device obtains a reference time from the monitoring server to timestamp the power reading data locally.

13. The monitoring system of claim 12 wherein the power reading data uploads to the monitoring server from the data collector device comprises either a latest reading data or a batch of readings that were collected within a configurable duration of time.

14. The monitoring system of claim 10 further comprising:
the monitoring server pushing the commands to the data collector device;
the data collector device communicating the commands to one or more of the plurality of monitoring devices; and
the one or more of the plurality of monitoring devices executing the commands received and delivering a response, if any, to the data collector device.

15. The monitoring system of claim 14 wherein the commands are one or more from the set comprising SETUP, POWEROFF, POWERON, LOWPOWER, HIGHPOWER, STANDBY, REPORT, RESET and CLEAR.

16. The monitoring system of claim 14 wherein the power reading data comprises at least the following items of information: identification, time, kilo-watt-hours, KWH-per-day, watts, amps and power factor.

17. A method of operating a monitoring system that monitors power consumption by appliances, the method comprising:
providing efficient billing display and tracking of a user's power usage information by an intelligent electricity meter electrically coupled to a plurality of appliances at a first premises;
tracking, by the intelligent electricity meter, a user's power usage information and mapping it to each of the plurality of appliances;
reporting the user's power usage information to a server by the intelligent electricity meter;
recommending, by the server, ways to reduce energy consumption by the user and mapping reduced energy consumption to money saved;
managing an energy saving contest, by the server; and
determining the user as a winner of the energy saving contest based on tracked power usage information of the user.

18. The method of claim 17 wherein the intelligent electricity meter is replaced by a collector device capable of collecting the user's power usage information and reporting it to the server, the method further comprising:
displaying the user's power usage information employing a GoogleMeter supported by the server;
monitoring power usage employing a plurality of monitoring devices, wherein each of the plurality of monitoring devices is plugged into a powerline and to at least one of a plurality of appliances;
receiving, by the collector device, commands from the server; and
sending, by the collector device, the commands to one or more of the plurality of monitoring devices in order to manage power consumed by the associated ones of the plurality of appliances.

19. The method of claim 18 wherein communication between the collector device and the plurality of monitoring devices occurs over a secure channel that employs encryption for security, wherein the commands are sent to the monitoring devices over the secure channel, the method further comprising:
conducting automatic and quick configuration when each of the monitoring devices are directly plugged into the collector device, wherein the quick configuration comprises creation and setup of a secure key for secure communications.

20. The method of claim 18 wherein tracking a user's power usage information associated with each of the plurality of appliances comprises periodically getting a power usage data from each of the plurality of monitoring devices, timestamping it, and storing it for local display and for subsequent reporting to the server.
